(19) United States
(12) Patent Application Publication
(10) Pub. No.: US 2024/0271450 A1
(43) Pub. Date: Aug. 15, 2024

(54) AUTOMATIC SWIMMING POOL CLEANER WITH MORE THAN ONE BATTERY PACK

(71) Applicant: ZODIAC POOL CARE EUROPE, Belberaud (FR)

(72) Inventor: Simon Duffaut, Castelginest (FR)

(73) Assignee: ZODIAC POOL CARE EUROPE, Belberaud (FR)

(21) Appl. No.: 18/440,548

(22) Filed: Feb. 13, 2024

Related U.S. Application Data
(60) Provisional application No. 63/445,287, filed on Feb. 13, 2023.

(51) Int. Cl. E04H 4/16; H02J 7/00

(52) U.S. Cl. CPC E04H 4/1654; H02J 7/0013

(57) ABSTRACT

An automatic swimming pool cleaner for a swimming pool or spa may include a housing and a plurality of battery packs supported on and/or within the housing. The automatic swimming pool cleaner may be operable with a single battery pack or with plurality of battery packs. The onboard power supply of the automatic swimming pool cleaner may be controlled without the automatic swimming pool cleaner needing recharging.

### REFERENCE TO RELATED APPLICATION

This application claims the benefit of U.S. Provisional Patent Application No. 63/445,287, filed on Feb. 13, 2023, and entitled AUTOMATIC SWIMMING POOL CLEANER WITH MORE THAN ONE BATTERY PACK, the content of which is hereby incorporated by reference in its entirety.

### FIELD OF THE INVENTION

The invention relates to systems and apparatuses for cleaning water-containing vessels such as swimming pools and spas and more particularly, although not necessarily exclusively, to automatic swimming pool cleaners (APCs).

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. Traditional APCs may include a single on-board battery pack such that the APC does not require cabling for receiving power from outside the pool or spa. However, APCs for large pools may run out of charge before completing an operation such as a cleaning cycle, thereby requiring an interruption to the cleaning cycle such that the APC can be recharged.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, an APC for a swimming pool or spa includes more than one battery pack.

According to various embodiments, a method includes supporting more than one battery packs on an APC based on a size of a swimming pool or spa to be cleaned.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates an APC according to embodiments.

### DESCRIPTION OF THE INVENTION

Described herein are APCs with more than one battery pack. In certain embodiments, the APCs described herein are operable with a single battery pack or the plurality of battery packs (e.g., two or more battery packs). The battery packs disclosed herein may allow for improved modularization and customization of the APC such that the onboard power supply may be adjusted as needed or desired, and power may be supplied without the APC needing recharging if so desired. As examples, the number of battery packs utilized may be based on a size of the pool or spa to be cleaned, a type of cleaning operation, etc. Various other benefits and advantages may be realized with the systems and methods provided herein, and the aforementioned advantages should not be considered limiting.

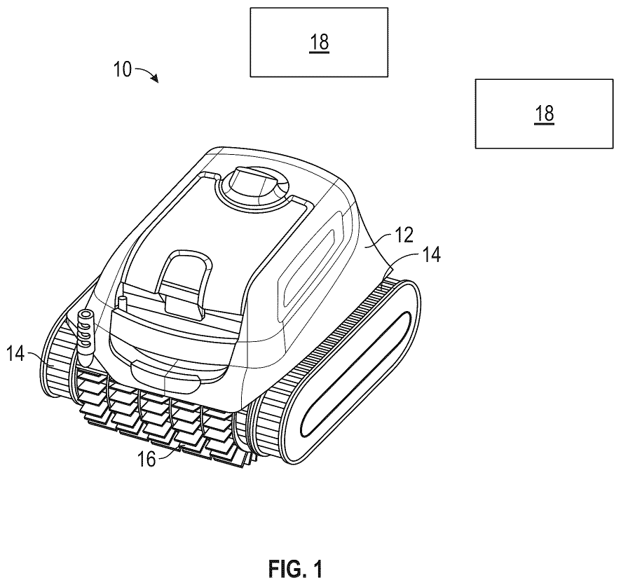

FIG. 1 illustrates an example of an APC 10 for performing various operations within a pool or spa according to embodiments. The APC 10 generally includes a body 12, one or more motive elements 14, and one or more cleaning devices (including, but not limited to, a scrubber brush 16). The motive elements 14 may be various suitable devices or structures suitable for enabling movement of the APC 10 along a surface, including but not limited to wheels, rollers, feet, tracks, combinations thereof, or any other devices or structures as desired. The cleaning devices may be various devices or structures suitable for cleaning a surface and/or directing debris into the APC 10 and/or towards a filter of the APC 10. A motor, pump, filter, and various other features may be provided on or within the APC 10 as desired. In various embodiments, a controller (e.g., processor and/or memory), an accelerometer, communication modules (e.g., an antenna, sensor, lights, speakers, etc.), combinations thereof, and/or other features and devices as desired may be included on the APC 10. Other non-limiting examples of APCs 10 may include those described in U.S. Pat. Nos. 10,316,534, 9,488,154, 8,578,538, and U.S. Patent Publication No. 2014/0303810, all of which are hereby incorporated by reference in their entireties.

In certain embodiments, more than one battery pack 18 may be provided with the APC 10. In various embodiments, the APC 10 may be operable with a single battery pack 18 supported on the APC 10 and/or with more than one of the battery packs 18 supported on the APC 10. As non-limiting examples, the APC 10 may utilize a single battery pack 18 for cleaning a small swimming pool or spa, and in such cases the unused battery pack(s) 18 may be charging and/or otherwise stored as desired. In some embodiments, an unused battery pack may be charged externally/separately while other battery packs are being used. In another non-limiting example, the APC 10 may include two battery packs 18, three battery packs 18, etc. to clean a large swimming pool or spa.

FIG. 1 illustrates the battery packs 18 removed from the APC 10, but the battery packs 18 may be attachable to and/or otherwise supported on the APC 10 at various locations and using various techniques as desired. As non-limiting examples, the battery packs 18 may be retained on and/or within the housing 12 and/or the battery packs 18 may be modules that are attachable to the housing 12. In certain embodiments, the battery packs 18 may be coupled with the components of the APC 10 which they are powering. Such couplings may be direct couplings (e.g., direct mating with components) or remote couplings (e.g., wiring or other suitable means for supplying power from the battery packs 18 to the components being powered when the components being powered are not physically contacting the battery packs 18). In certain embodiments, the battery packs 18 may be mechanically connected or coupled to each other using various mechanisms or features when provided on the APC 10 at the same time. Such mechanisms or features may include, but are not limited to, tabs, hooks, snap-fit connections, clips, clasps, male and female connections, threaded fasteners, pins, combinations thereof, and/or other devices or mechanisms as desired. In other embodiments, when more than one battery pack 18 is provided at the same time, they need not be mechanically connected to each other.

Each battery pack 18 of the more than one battery packs 18 includes a store of electricity (e.g., one or more batteries). In certain embodiments, each battery pack 18 may be a same type of battery pack (e.g., same type of battery, same battery size, same energy storage capacity, same chemical construction, all rechargeable, all single-use or non-rechargeable, same number of batteries, etc.). However, in other embodiments, the battery packs 18 need not be the same. As non-limiting examples, the type of battery and/or number of batteries provided within one battery pack 18 may be the same as or different from the type and/or number of batteries provided within another battery pack 18.

Optionally, one or more of the battery packs 18 may be rechargeable, and in such embodiments, the one or more battery packs 18 may include electrically conductive portions and/or other features that may be used to charge and/or recharge the stores of electricity as desired.

As mentioned, the APC 10 may be operable with one battery pack 18 and/or with more than one battery pack 18 as desired. In embodiments where the APC 10 operates with more than one battery pack 18, the motor and/or other electronic components of the APC 10 may draw power from the battery packs 18 sequentially (e.g., one at a time) or concurrently as desired. In certain embodiments, the number of battery packs 18 supported on the APC 10 may be based on a size of the pool or spa to be cleaned, a type of cleaning operation to be performed by the APC 10, a desired time until recharge of the battery pack(s) 18, etc.

In some embodiments, the APC 10 (and/or electronic components of the APC 10) may be controlled to draw power from the battery packs 18 sequentially or concurrently based on an onboard controller (e.g., processor and/or memory), user input, sensed or detected input, and/or as otherwise desired. As non-limiting examples, a user may provide an input to the APC 10 (e.g., via a user interface on the APC 10, via wired communication, via wireless communication from a remote user device, etc.) indicating and/or controlling the APC 10 such that the power is drawn concurrently or sequentially as desired.

As another non-limiting example, the APC 10 (e.g., via the controller) may control electronic components of the APC 10 such that power is drawn concurrently or sequentially based on an input, determined, and/or sensed size of the pool or spa to be cleaned, a type of cleaning operation to be performed by the APC, a desired time until recharge of the battery packs, a type of battery pack, a current charge level of the battery packs, combinations thereof, and/or as otherwise desired. As a non-limiting example, the APC 10 may be in a first operation mode (e.g., drawing power from a single battery pack) or a second operation mode (e.g., drawing power from a plurality of battery packs) based on a pool size being above, below, or at a threshold pool area and/or a desired time until recharge being above, below, or at a threshold duration. As another non-limiting example, the APC 10 may be in the first operation mode or the second operation mode based on a cleaning operation being a first type of cleaning operation predicted or determined to draw a first amount of power (e.g., travelling along a floor with brushes active), a second type of cleaning operation predicted or determined to draw a second amount of power (e.g., travelling along both a floor of the pool and vertical walls of the pool with brushes active), etc. As yet another non-limiting example, the APC 10 may be in the first operation mode or the second operation mode based on the batteries being rechargeable or non-rechargeable, energy storage capacity, etc.

Various other control of power draw from the battery packs may be implemented as desired, and the aforementioned examples are for illustrative purposes only.

Exemplary concepts or combinations of features of the invention may include:
A. An APC for a swimming pool or spa, the APC comprising more than one battery pack.
B. The APC of any preceding or subsequent statement or combination of statements, wherein the more than one battery packs are connected together.
C. The APC of any preceding or subsequent statement or combination of statements, wherein the more than one battery packs comprises two battery packs.
D. The APC of any preceding or subsequent statement or combination of statements, wherein the APC is operable with a single battery pack of the more than one battery packs or with all of the battery packs.
E. The APC of any preceding or subsequent statement or combination of statements, wherein the battery packs are rechargeable battery packs.
F. The APC of any preceding or subsequent statement or combination of statements, wherein each battery pack of the more than one battery packs is a same type of battery pack.
G. The APC of any preceding or subsequent statement or combination of statements, wherein at least one battery pack of the more than one battery packs is different from another battery pack of the more than one battery packs.
H. The APC of any preceding or subsequent statement or combination of statements, wherein the APC is configured to draw power from the more than one battery packs sequentially or concurrently.
I. A method comprising supporting more than one battery packs on an APC based on a size of a swimming pool or spa to be cleaned.
J. An APC for a swimming pool or spa, the APC comprising a housing, motive elements configure to enable movement of the APC along a surface, and a plurality of battery packs supported on and/or within the housing.
K. The APC of any preceding or subsequent statement or combination of statements, wherein the plurality of battery packs are mechanically connected together.
L. The APC of any preceding or subsequent statement or combination of statements, wherein, in a first operation mode, the APC is operable with a single battery pack of the plurality of battery packs, and wherein in a second operation mode, the APC is operable with all of the battery packs of the plurality of battery packs.
M. The APC of any preceding or subsequent statement or combination of statements, wherein the APC is configured to operate in the first operation mode or the second operation mode based on a size of the pool or spa to be cleaned, a type of cleaning operation to be performed by the APC, or a desired time until recharge of the battery packs.
N. The APC of any preceding or subsequent statement or combination of statements, wherein a number of the plurality of battery packs is based on a size of the pool or spa to be cleaned, a type of cleaning operation to be performed by the APC, or a desired time until recharge of the battery pack.
O. The APC of any preceding or subsequent statement or combination of statements, wherein an unused battery pack may be charged externally/separately while other battery packs are being used
P. The APC of any preceding or subsequent statement or combination of statements, wherein the APC is configured to draw power from the plurality of battery packs sequentially.
Q. The APC of any preceding or subsequent statement or combination of statements, wherein the APC is configured to draw power from the plurality of battery packs concurrently.
R. A method of operating an APC comprising supporting a plurality of battery packs on and/or within a housing of the APC based on a size of a swimming pool or spa to be cleaned, wherein the APC further comprises motive elements configure to enable movement of the APC along a surface.
S. The method of any preceding or subsequent statement or combination of statements further comprising operating the APC such that the APC draws power from the plurality of battery packs, wherein operating the APC comprises drawing power from the plurality of battery packs sequentially.
T. The method of any preceding or subsequent statement or combination of statements, further comprising operating the APC such that the APC draws power from the plurality of battery packs, wherein operating the APC comprises drawing power from the plurality of battery packs concurrently.
U. The method of any preceding or subsequent statement or combination of statements, wherein supporting the plurality of battery packs comprises mechanically connecting the plurality of battery packs.
V. The method of any preceding or subsequent statement or combination of statements, further comprising operating the APC in a first operation mode in which the APC is operable with a single battery pack of the plurality of battery packs, or operating the APC in a second operation mode in which the APC is operable with all of the battery packs of the plurality of battery packs.
W. The method of any preceding or subsequent statement or combination of statements, further comprising controlling the APC to operate in the first operation mode or the second operation mode based on the size of the pool or spa to be cleaned.
X. The method of any preceding or subsequent statement or combination of statements, further comprising controlling the APC to operate in the first operation mode or the second operation mode based a type of cleaning operation to be performed by the APC.
Y. The method of any preceding or subsequent statement or combination of statements, further comprising controlling the APC to operate in the first operation mode or the second operation mode based on a desired time until recharge of the battery packs.
Z. The method of any preceding or subsequent statement or combination of statements, further comprising controlling the APC to operate in the first operation mode or the second operation mode based on a type of battery pack.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. An automatic pool cleaner (APC) for a swimming pool or spa, the APC comprising a housing, motive elements configure to enable movement of the APC along a surface, and a plurality of battery packs supported on and/or within the housing.

2. The APC of claim 1, wherein the plurality of battery packs are mechanically connected together.

3. The APC of claim 1, wherein the plurality of battery packs comprises two battery packs.

4. The APC of claim 1, wherein, in a first operation mode, the APC is operable with a single battery pack of the plurality of battery packs, and wherein in a second operation mode, the APC is operable with all of the battery packs of the plurality of battery packs.

5. The APC of claim 4, wherein the APC is configured to operate in the first operation mode or the second operation mode based on a size of the pool or spa to be cleaned, a type of cleaning operation to be performed by the APC, or a desired time until recharge of the battery packs.

6. The APC of claim 1, wherein an unused battery pack may be be charged externally/separately while other battery packs are being used.

7. The APC of claim 1, wherein a number of the plurality of battery packs is based on a size of the pool or spa to be cleaned, a type of cleaning operation to be performed by the APC, or a desired time until recharge of the battery pack.

8. The APC of claim 1, wherein the battery packs are rechargeable battery packs.

9. The APC of claim 1, wherein each battery pack of the plurality of battery packs is a same type of battery pack.

10. The APC of claim 1, wherein at least one battery pack of the plurality of battery packs is different from another battery pack of the plurality of battery packs.

11. The APC of claim 1, wherein the APC is configured to draw power from the plurality of battery packs sequentially.

12. The APC of claim 1, wherein the APC is configured to draw power from the plurality of battery packs concurrently.

13. A method of operating an automatic swimming pool cleaner (APC) comprising supporting a plurality of battery packs on and/or within a housing of the APC based on a size of a swimming pool or spa to be cleaned, wherein the APC further comprises motive elements configure to enable movement of the APC along a surface.

14. The method of claim 12, further comprising operating the APC such that the APC draws power from the plurality of battery packs, wherein operating the APC comprises drawing power from the plurality of battery packs sequentially.

15. The method of claim 12, further comprising operating the APC such that the APC draws power from the plurality of battery packs, wherein operating the APC comprises drawing power from the plurality of battery packs concurrently.

16. The method of claim 12, wherein supporting the plurality of battery packs comprises mechanically connecting the plurality of battery packs.

17. The method of claim 12, further comprising operating the APC in a first operation mode in which the APC is operable with a single battery pack of the plurality of battery packs, or operating the APC in a second operation mode in which the APC is operable with all of the battery packs of the plurality of battery packs.

18. The method of claim 16, further comprising controlling the APC to operate in the first operation mode or the second operation mode based on a size of the pool or spa to be cleaned.

19. The method of claim 16, further comprising controlling the APC to operate in the first operation mode or the second operation mode based a type of cleaning operation to be performed by the APC.

20. The method of claim 16, further comprising controlling the APC to operate in the first operation mode or the second operation mode based on a desired time until recharge of the battery packs.

21. The method of claim 16, further comprising controlling the APC to operate in the first operation mode or the second operation mode based on a type of battery pack.
